(19) United States
(12) Patent Application Publication
(10) Pub. No.: US 2012/0106793 A1
(43) Pub. Date: May 3, 2012

(54) METHOD AND SYSTEM FOR IMPROVING THE QUALITY AND UTILITY OF EYE TRACKING DATA

(76) Inventors: Joseph A. Gershenson, Sunnyvale, CA (US); Brian Krausz, Sunnyvale, CA (US)

(21) Appl. No.: 13/286,162

(22) Filed: Oct. 31, 2011

Related U.S. Application Data
(60) Provisional application No. 61/408,467, filed on Oct. 29, 2010.

(51) Int. Cl. G06K 9/00

(52) U.S. Cl. 382/103

(57) ABSTRACT

A system and method for interpreting eye-tracking data are provided. The system and method comprise receiving raw data from an eye tracking study performed using an eye tracking mechanism and structural information pertaining to an electronic document that was the subject of the study. The electronic document and its structural information are used to compute a plurality of transition probability values. The eye-tracking data and the transition probability values are used to compute a plurality of gaze probability values. Using the transition probability values and the gaze probability values, a maximally probably transition sequence corresponding to the most likely direction of the user's gaze upon the document is identified.

### RELATED APPLICATIONS

This application claims priority, under 35 U.S.C. §119, to U.S. Provisional Patent Application No. 61,408,467 titled “Systems and Methods for Improving the Quality and Utility of Eye Tracking Data”, which was filed on Oct. 29, 2010 and is incorporated herein by reference.

### FIELD OF THE INVENTION

The technology described herein relates to eye tracking. Specifically, the technology improves the accuracy of eye tracking studies and makes the results of these studies easier to analyze and understand.

### BACKGROUND

Over the past three decades, computing, especially online computing, has proliferated to the point of ubiquity. Whereas computing and computer systems were initially common only in enterprise settings, most individuals and families today own and regularly use a networked computing device of some type. This rise in computing has both fueled and been fueled by research geared toward understanding how people interact with user interfaces and digital content. The emergence of the Internet as a powerful medium for delivering rich content has further driven the need to discern user intuition in viewing and interacting with digital media so that content and applications may be designed accordingly. The usability of web pages and web applications can be enhanced by determining which portions of a document the user pays most attention to and the order in which he views them. Web usability and user interface experts are increasingly relying upon eye tracking data to draw such inferences.

Eye tracking is the process of measuring the point of a person's gaze upon a surface. In the context of computing, eye tracking techniques may be used to discern the position of a viewer's gaze upon a computer screen. This data may be collected with a video camera mounted above a computer screen and positioned toward a viewer's face accompanied by software that automatically recognizes the viewer's eyes within the captured image. However, the raw data yielded by such techniques is noisy, imprecise, and cannot be relied upon exclusively to convey the position of a user's gaze at a given moment. The hardware limitations and the inherent obstacles in tracking the position of a minute, constantly moving object such as an eyeball make it difficult to collect data that can be used to accurately determine gaze points. Enhancing the precision of video cameras, sensors, or other hardware equipment used to capture eye position may improve the accuracy of the raw data, but can be difficult and cost-prohibitive.

A number of techniques for interpreting eye tracking data seek to improve its utility by displaying it in an illustrative manner. One such technique is presenting the data in the form of a heat map. This technique allowing a user to determine overarching themes in eye tracking data. However, heat maps are inherently not quantitative and do not allow a user to examine detailed statistics or infer precise usage patterns. Another such technique is presenting the data in an area of interest plot. Area of interest plots overcome some of the limitations of heat maps and allow quantitative analysis of areas relative to each other. However, they require that the content being analyzed be manually divided into its various regions of interest, which is a tedious and time-consuming process.

Thus, what is needed is a technique for interpreting eye-tracking data that accounts for its imprecision without and allows for quantitative analysis of viewing patterns without the limitations of existing prior art techniques. As will be shown, the present invention provides such a technique in an elegant manner.

### SUMMARY

The present invention introduces a method and system for processing data received from an eye tracking mechanism.

According to the invention, data corresponding to a plurality of observed positions of a user's gaze upon an electronic document at a plurality of timesteps is received. The data may be received from any type of eye tracking mechanism. Structural data corresponding to the electronic document is received. The structural data corresponding to the electronic document is processed. According to an embodiment, processing the structural data corresponding to the electronic document comprises modeling the electronic document as a plurality of data objects. A plurality of transition probability values corresponding to the probability of the user's gaze transitioning from the observed positions to each of a plurality of regions within the electronic document is calculated. A plurality of gaze probability values corresponding to the probability of determining the position of the user's gaze for each of the timesteps is calculated using the observed positions and the transition probability values. According to one embodiment, a plurality of transition probability rules is received, and the plurality of transition probability values are further calculated using the transition rules. At least one maximally probable transition sequence is calculated using the gaze probability values and the transition probability values.

According to one embodiment, the transition probability values and the gaze probability values are calculated using a hidden Markov model. According to another embodiment, the maximally probable transition sequence is calculated using a Viterbi algorithm. According to yet another embodiment, the electronic document is a webpage. According to yet another embodiment, the electronic document is a spreadsheet. According to yet another embodiment, the electronic document is a word processing document. According to yet another embodiment, the structural data is received in the form of an Extensible Markup Language (XML) schema. According to yet another embodiment, the structural data conforms to a Document Object Model (DOM) standard.

### BRIEF DESCRIPTION OF THE DRAWINGS

FIG. 1 depicts a flow diagram illustrating the operation of the invention according to an embodiment.

FIG. 2 depicts a flow diagram illustrating the operation of the invention according to an embodiment.

FIG. 3 depicts a flow diagram illustrating the operation of the invention according to an embodiment.

FIG. 4A depicts diagram illustrating a Hidden Markov model according to an embodiment of the invention.

FIG. 4B depicts a diagram illustrating an observed transition sequence according to an embodiment of the invention.

FIG. 4C depicts a diagram illustrating transition sequence probabilities represented in a Hidden Markov Model according to an embodiment of the invention.

FIG. 4D depicts a table listing transition probability values according to an embodiment of the invention.

FIG. 4E depicts a diagram illustrating gaze probabilities represented in a Hidden Markov Model according to an embodiment of the invention.

FIG. 4F depicts a table listing gaze probability values according to an embodiment of the invention.

FIG. 4G depicts calculated transition sequence probability values according to an embodiment of the invention.

FIG. 4H depicts a diagram illustrating the results of a Viterbi algorithm according to an embodiment of the invention.

FIG. 5A depicts an example webpage used with an embodiment of the invention.

FIG. 5B depicts the results of an eye tracking study overlaid on an example webpage according to an embodiment of the invention.

FIG. 5C depicts an example webpage divided into region and labeled with each region's corresponding data object according to an embodiment of the invention.

FIG. 5D depicts a table listing transition probability values according to an embodiment of the invention.

FIG. 5E depicts three tables listing gaze probability values according to an embodiment of the invention.

FIG. 6 depicts an example visual interface according to en embodiment of the invention.

FIG. 7 depicts a diagram illustrating an exemplary environment for the operation of the methods and systems comprising the present invention according to an embodiment.

FIG. 8 depicts a diagram illustrating an exemplary hardware implementation for the operation of the methods and systems comprising the present invention according to an embodiment

### DETAILED DESCRIPTION

Eye tracking, or calculating the gaze position of the human eye, is commonly used to study user interactions with electronic media. Computer user interface designers and usability experts are increasingly using eye tracking data to study how people interact with computing devices and the content they view on them. Understanding the intuition of a user and the direction of his focus on various aspects of a webpage, for example, can enable web designers to place advertising and other high-value content such that it would be most likely to capture the user's attention.

However, the limited accuracy and noisiness of eye tracking data has hindered the adoption of this technology. Raw eye tracking data collected from video camera images is imprecise and cannot be relied upon to pinpoint the position of a user's gaze at a given moment. One approach to interpreting such data is to account for its imprecision by estimating the likelihood that the user's gaze is pointed at various positions in a document at a particular moment given the observed position of the user's eye at that moment. According to this procedure, once these likelihoods are determined, the likelihood that the user's gaze will shift from these positions to adjoining regions is then calculated. Data from eye tracking studies and usability metrics that establish tendencies of people to focus their attention on certain aspects of a picture or a document may be used to derive such likelihoods. Examples of such studies in the prior art include Itti, Laurent, and Christof Koch, “Computational modeling of visual attention” Vision Research 42 (2002): 107-123; and Kastner, Sabine, and Leslie Ungerleider, “Mechanisms of Visual Attention in the Human Cortex” Annual Review of Neuroscience (2000) 23: 315-341.

Unfortunately, the approach of relying on these assumptions alone is limited because the applicability of a particular set of assumptions can never be determined with total certainty. For example, the assumption that people viewing photographs initially focus on faces is applicable if it is known that the user is viewing a photograph, but unhelpful if the subject of the viewer's gaze is not known.

The present invention addresses these shortcomings by providing a system and method for interpreting raw eye tracking data that incorporates the structural information of the document being analyzed. Many electronic documents include metadata that describes the structural elements comprising the document according to a universal convention. For example, Hypertext Markup Language (HTML) and Cascading Style Sheets (CSS) define the layout and structural components of a webpage. Many other types of documents are accompanied by structural metadata based on the Extensible Markup Language (XML) standard. According to embodiments of the present invention, this structural information is extracted from the document and utilized to determine which part of the document a user's gaze position corresponds to.

The technique of the present invention utilizes the raw data received from an eye tracking mechanism to model the actual position of a user's gaze. Eye-tracking mechanisms typically rely on video camera images of users interacting with a computer screen and eye recognition technology that locates the user's face and eyes within the image. There are many eye tracking mechanisms in the prior art that produce data suitable for use with the present invention. Example prior art techniques are described in Li et. al. “Open-Source Software for Real-Time Visible Spectrum Eye Tracking” Proceedings of The 2nd Conference on Communication by Gaze Interaction, 2006; and R. J. K. Jacob, “The use of eye movements in human computer interaction techniques: What you look at is what you get,” ACM Transactions on Information Systems, vol. 9, no. 3, pp. 152-169, 1991. Any eye-tracking mechanism may be used without deviating from the spirit or scope of the invention.

The data received from the eye tracking mechanism is used in a Hidden Markov model. A Hidden Markov model is a statistical model used primarily to recover a data sequence that is not immediately observable. The model derives probability values for the unobservable data sequence by interpreting other data that depends on that sequence and is immediately observable. According to an embodiment, the Hidden Markov model of the present invention represents the visible output (the raw data received from the eye-tracking mechanism) as a randomized function of an invisible internal state (where the user was actually looking.) The Hidden Markov model is initialized using data collected from the structural information of the document being analyzed. A Viterbi algorithm is then used to compute the most likely sequence of gaze points from the derived probability values. From this information, the most likely position of the user's gaze upon a document at any given moment can be determined.

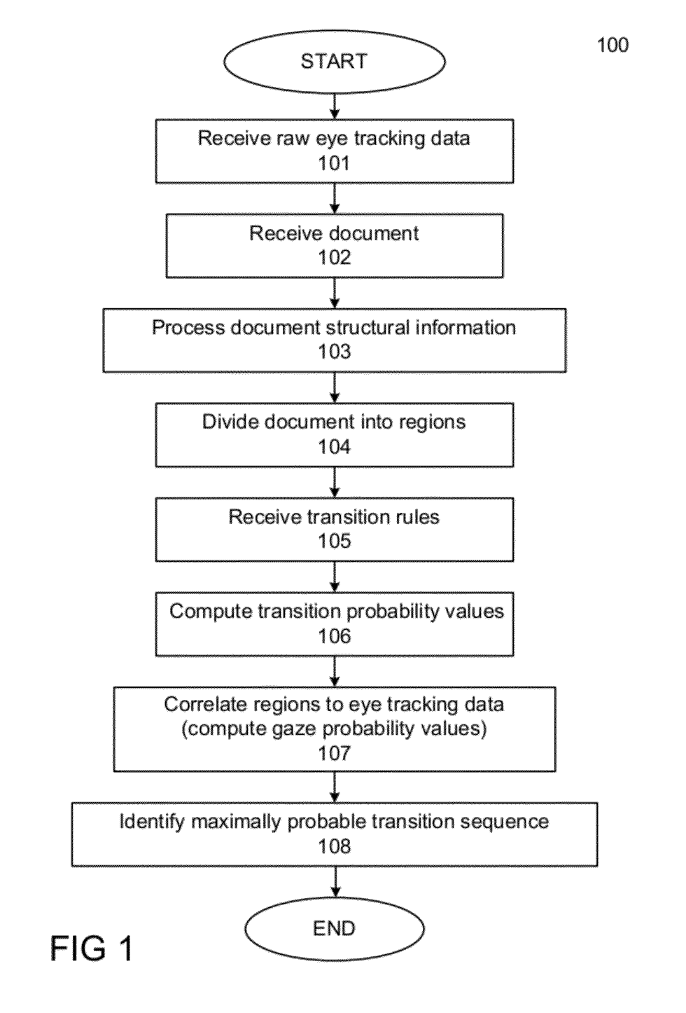

A flow diagram 100 illustrating the operation of the present invention according to an embodiment is depicted in FIG. 1. At step 101, raw eye tracking data is received from an eye tracking mechanism. The data is collected in advance of the present method's execution. As noted above, any eye tracking mechanism may be used without deviating from the spirit or scope of the invention. At step 102, the document being viewed by the user is received. The document is accompanied by structural information describing the layout and data objects that comprise the document. At step 103, the structural information of the document is processed, and the data objects comprising the document and their layout are identified. At step 104, the document is divided into regions. According to one embodiment, the regions may be as small as a single pixel. These regions represent the possible positions of the user's gaze at a given moment. Any region size may be used without deviating from the spirit or scope of the invention. According to one embodiment, the regions are overlaid with the data objects identified in step 103 such that each region corresponds to a data object within the document.

At step 105, transition rules are received based on the structural information of the document received in step 102. According to one embodiment, these rules may be simple assumptions based on known natural human tendencies. For example, in single-column English-language documents, a user is more likely to transition his gaze from left to right than from right to left. Alternatively, the rules may be derived from complex usage patterns determined from studies pertaining to the type of document being viewed. Any system of transition rules may be used without deviating from the spirit or scope of the invention. At step 106, probability values for each possible transition between two regions of the document are computed using the structural information of the document processed in step 103 and the transition rules received in step 105. According to one embodiment, these transition probability values are computed by initializing a Hidden Markov model using the transition rules and the structural information of the document. Any technique for calculating the transition probability values may be used without deviating from the spirit or scope of the invention.

At step 107, the regions are correlated to the received eye tracking data. This step results in a plurality of gaze probability values indicating the probability that the user's gaze was focused upon a particular region at a moment in time given the raw eye-tracking data for that moment in time. According to one embodiment, the moments in time may be represented as timesteps of discrete length, and the gaze probabilities may be modeled as a matrix of values for each timestep. Any division of timesteps or technique for modeling the gaze probability values may be used without deviating from the spirit or scope of the invention. The gaze probability values correspond to the distribution of noise in the raw data received from the eye tracking mechanism. According to one embodiment, the gaze probability value for each region is calculated to be inversely proportional to the distance between that region and the region corresponding to the position of the user's eye as detected by the eye-tracking mechanism. Any technique for estimating the gaze probability values may be used without deviating from the spirit or scope of the invention.

At step 108, a maximally probable transition sequence is identified using the transition probability values computed in step 106 and the gaze probability values computed in step 107, and the method concludes. According to one embodiment, the maximally probably transition sequence may be computed using a Viterbi algorithm. Any technique for computing the maximally probably transition sequence may be used without deviating from the spirit or scope of the invention.

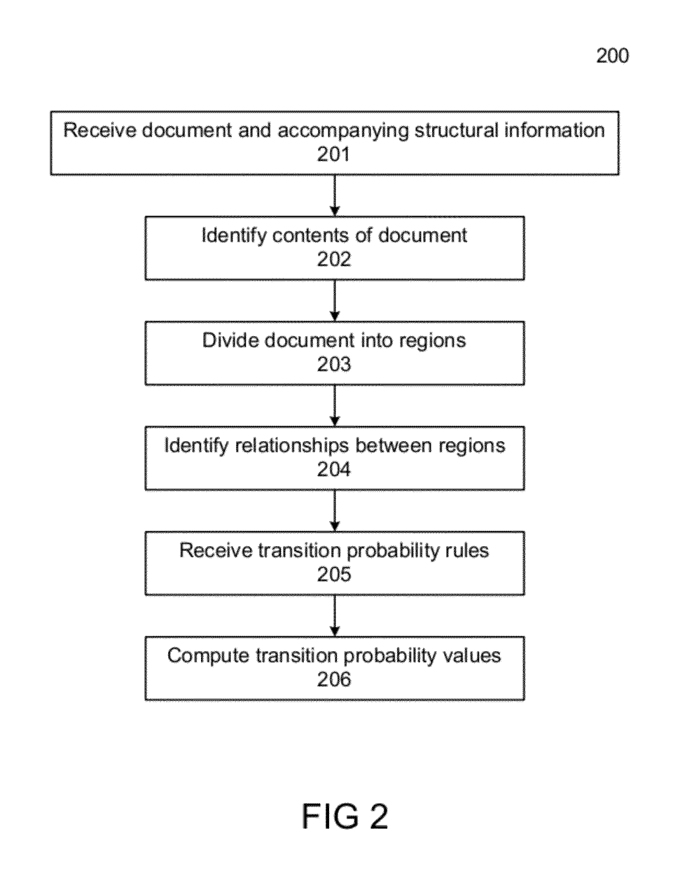

Steps 102-104 of FIG. 1 are illustrated in further detail according to an embodiment by the flow diagram 200 depicted in FIG. 2. At step 201, the document and its structural information are received. At step 202, the contents of the document are identified using the structural information. According to one embodiment, these contents may comprise discrete data objects corresponding to elements within the document. At step 203, the document is divided into regions. At step 204, the regions are labeled with the contents identified in step 202. At step 204, the relationships between the regions within the document are identified. For example, discrete text that is placed below an image may be identified as a caption to that image. At step 205, transition probability rules are received based on the document's contents. At step 206, probability values for each possible transition between two regions of the document are computed using the document's structural information and the transition rules. This is done independently of the eye-tracking data received in step 101 of FIG. 1.

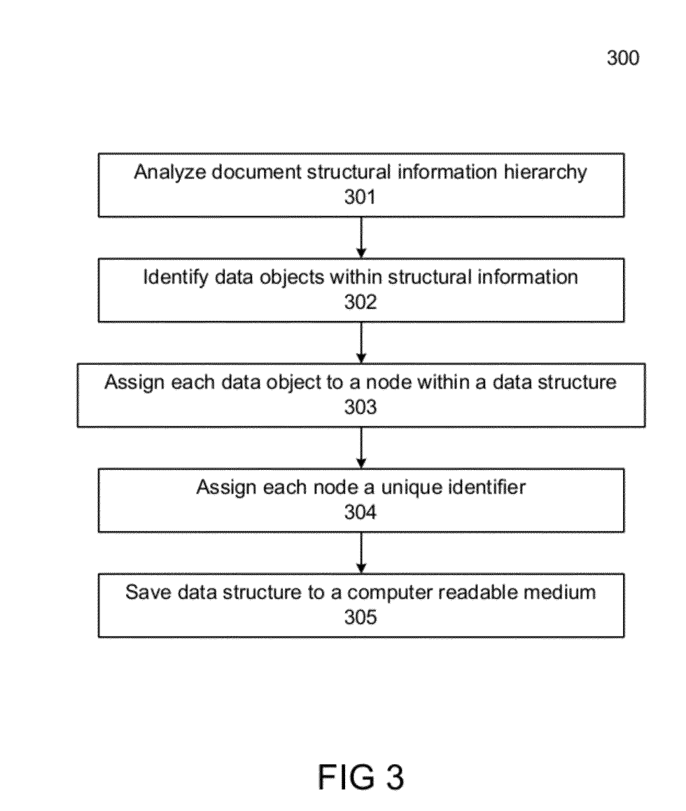

Steps 103-104 of FIG. 1 and steps 202-204 of FIG. 2 are illustrated in further detail by the flow diagram 300 depicted in FIG. 3. At step 301, the structural information hierarchy of the document is analyzed. At step 302, the data objects in the structural information are identified. At step 303, each data object is assigned to a node within a data structure. At step 304, a unique identifier is assigned to each node. According to one embodiment, the unique identifier links each node to its parent, such that the data object hierarchy within the document is preserved in the data structure. At step 305, the data structure is saved to a computer-readable storage medium. According to one series of embodiments, the structural information may be received in a format that conforms to a document object model (DOM) standard. In one such embodiment, the structural information may be received in the form of an XML schema. However, any format for representing a document's structural information may be used without deviating from the spirit or scope of the invention.

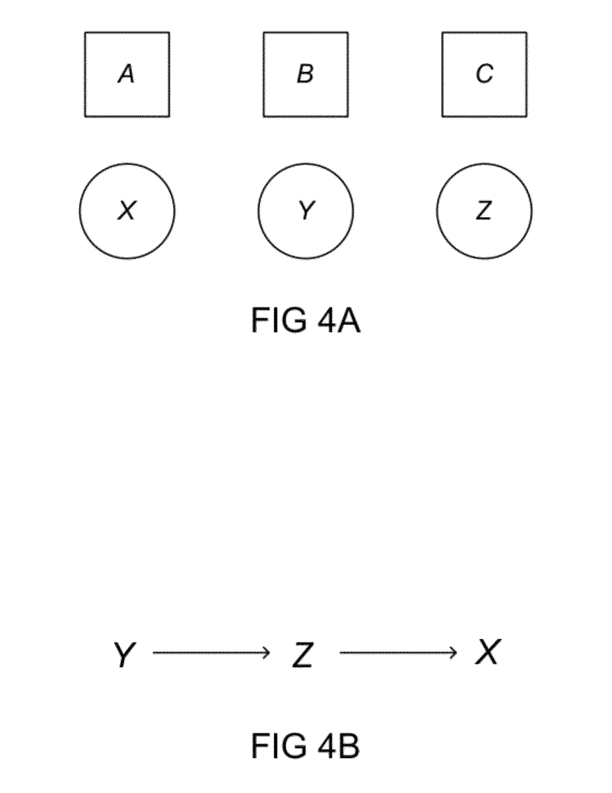

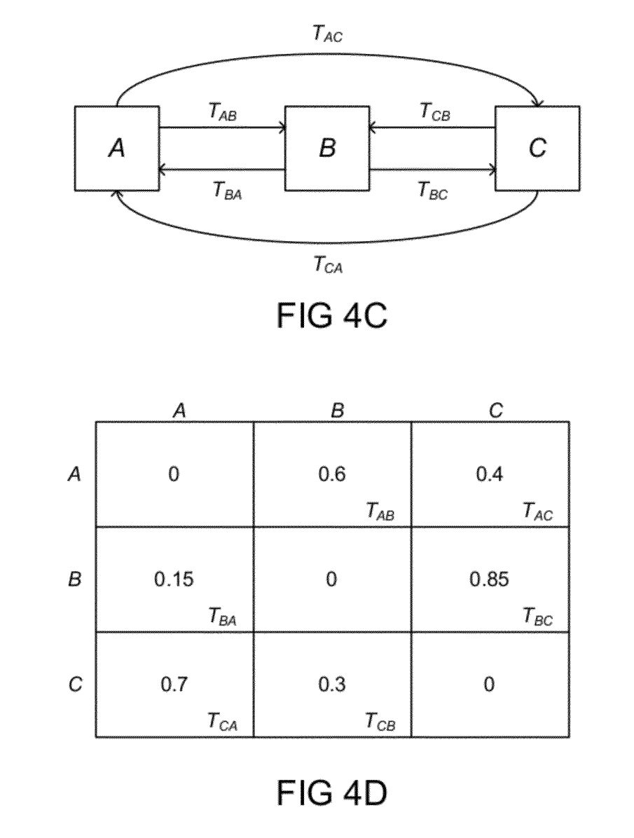

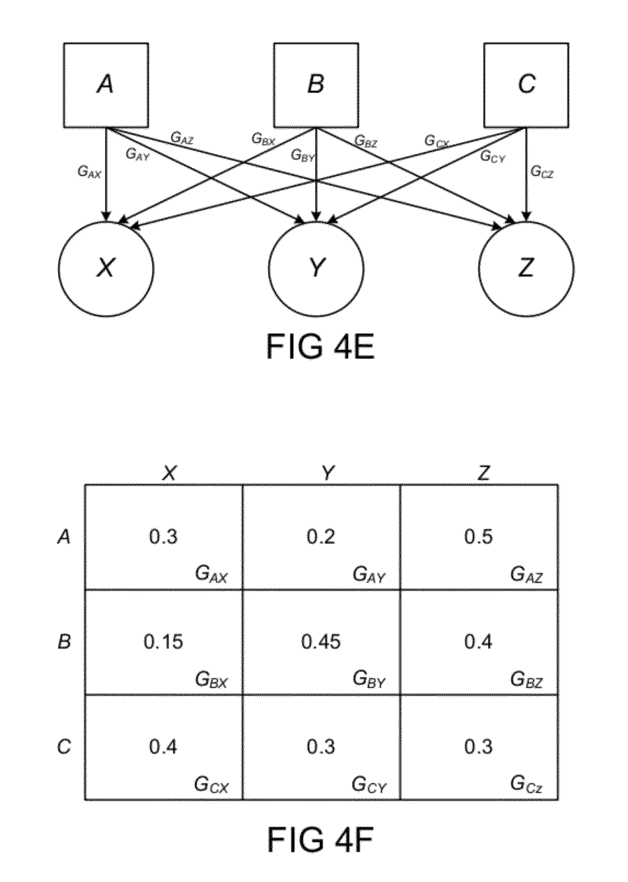

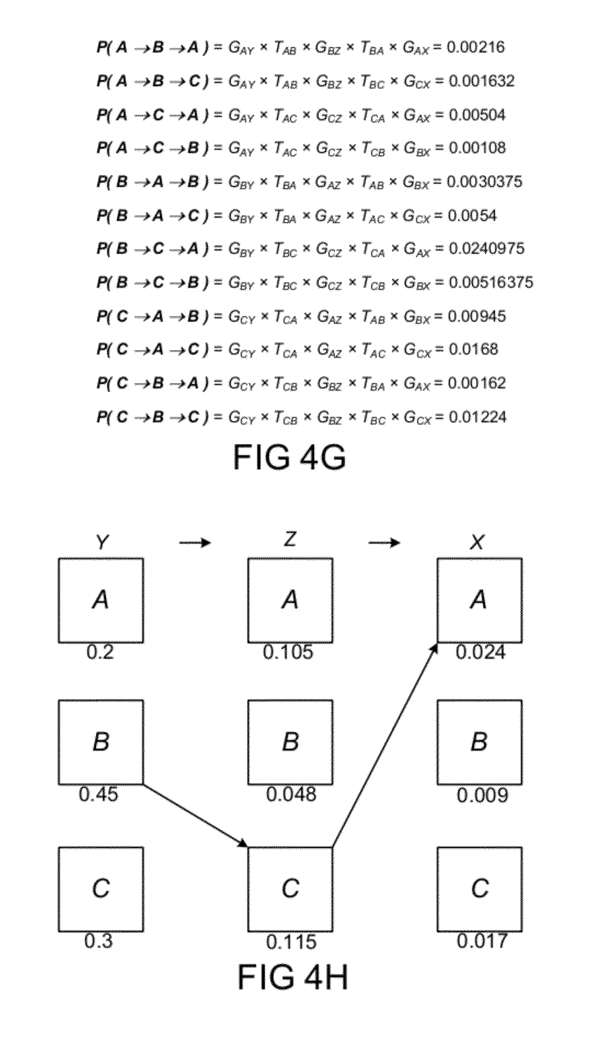

Steps 106-108 of FIG. 1 are further illustrated according to one series of embodiments by FIGS. 4A-4H. In this series of embodiments, a Hidden Markov model is used to calculate the transition probability values and the gaze probability values in steps 106 and 107, respectively. FIG. 4A illustrates a portion of a hidden Markov model. In the illustrated model, the hidden states A, B, and C represent three distinct regions of the document, any one of which may correspond to the actual position of the user's gaze. The output symbols X, Y, and Z represent the observed position of the user's eye as detected by the eye-tracking mechanism. In FIG. 4B, The sequence Y→Z→X represents an observed transition sequence of the user's eyes as detected by the eye-tracking mechanism. Thus, Y→Z→X corresponds to a known sequence of data points—in this case, the observed position of the user's eye—that resulted from some unknown sequence of hidden states—in this case, the actual position of the user's gaze. The goal is to determine the sequence of hidden states depicted in FIG. 4A that resulted in the sequence of output symbols depicted in FIG. 4B.

FIG. 4C depicts transition probabilities T_{AB}, T_{AC}, T_{BA}, T_{BC}, T_{CA}, and T_{CB} representing the probabilities that the user's gaze will transition from A to B, A to C, B to A, B to C, C to A, and C to B, respectively. The transition probability values are computed in step 106 using the transition rules received in step 105, which are based on the structural information of the document, the language of the document, document type, and any other factors pertaining to the document that may be identified. Any technique for deriving the transition probability values from the transition rules may be used without deviating from the spirit or scope of the invention. FIG. 4D depicts a table listing the transition probability values used in this example, as determined using a set of transition rules. For simplicity, a transition between document regions is defined in this example as a shift of the user's gaze from one document region to a different document region. Hence, a state cannot transition to itself.

FIG. 4E depicts gaze probabilities G_{AX}, G_{AY}, G_{AZ}, G_{Bx}, G_{BY}, G_{BZ}, G_{CX}, G_{CY}, and G_{CZ} representing the probability that the user's gaze is focused on: A given the user's observed eye position X, A given the user's observed eye position Y, A given the user's observed eye position Z, B given the user's observed eye position X, B given the user's observed eye position Y, B given the user's observed eye position Z, C given the user's observed eye position X, C given the user's observed eye position Y, and C given the user's observed eye position Z, respectively. The gaze probability values are computed in step 107 using the raw eye tracking data received in step 101. FIG. 4F depicts a table listing the gaze probability values used in this example, as determined using example eye tracking data. Thus, the most probable document region corresponding to observed eye position X is C, the most probable document region corresponding to observed eye position Y is B, and the most probable document region corresponding to observed eye position Z is A.

In this example, it is assumed that the start probabilities—i.e., the probability that each of the document regions was the first region upon which the user focused his gaze—are equivalent for all document regions. Because there are 3 document regions in this example, and because no state can transition to itself and hence no region can appear consecutively in a sequence, the number of possible transition sequences is 3³−(3×5)=12. The most likely document region transition sequence that resulted in the observed eye position transition sequence Y→Z→X depicted in FIG. 4B can be determined by multiplying the applicable transition probability values and gaze probability values for each of the 12 possible transition sequences. FIG. 4G depicts these calculations for each sequence, using the transition probability values listed in FIG. 4D and the gaze probability values listed in FIG. 4F. As shown in FIG. 4G, the highest product of these probability calculations is 0.0240975, and the maximally probable transition sequence is thus B→C→A.

Because the number of regions and possible transition sequences in the present example is minimal, the maximally probable transition sequence can be easily identified by simply calculating all of the probabilities and selecting the highest one. However, this may not be efficient for complex documents with hundreds or potentially thousands of regions and data objects, According to one embodiment, a Viterbi algorithm may be used to determine the maximally probably transition sequence without having to calculate probabilities for every possible transition sequence. FIG. 4H depicts a diagram illustrating the operation of a Viterbi algorithm. The values listed in the diagram of FIG. 4H are intermediate values calculated at each step of the algorithm. These values represent the probability that the true gaze of the user corresponds to a particular region given the observations made and probabilities computed up to that point in the user's gaze sequence. Each column represents a step in the algorithm. The values in the first column represent the probabilities that the user's actual gaze corresponds to regions A, B, and C given that the observed position of the user's eye is Y. Because the probability value corresponding to B is highest, B is selected. The values in the second column represent the probabilities that the user's gaze transitioned from region B to each of regions A, B, and C given that the observed position of the user's eye is Z. Because the probability value corresponding to C is highest, C is selected. The values in the third column represent the probabilities that the user's gaze transitioned from region B to region C to each of regions A, B, and C given that the observed position of the user's eye is X. Because the probability value corresponding to A is highest, A is selected. Thus, using the Viterbi algorithm, B→C→A can be identified as the most likely document region transition sequence that resulted in the observed eye position transition sequence Y→Z→X. This is identical to the result determined above. Any technique for finding a maximally probable transition sequence may be used without deviating from the spirit or scope of the invention.

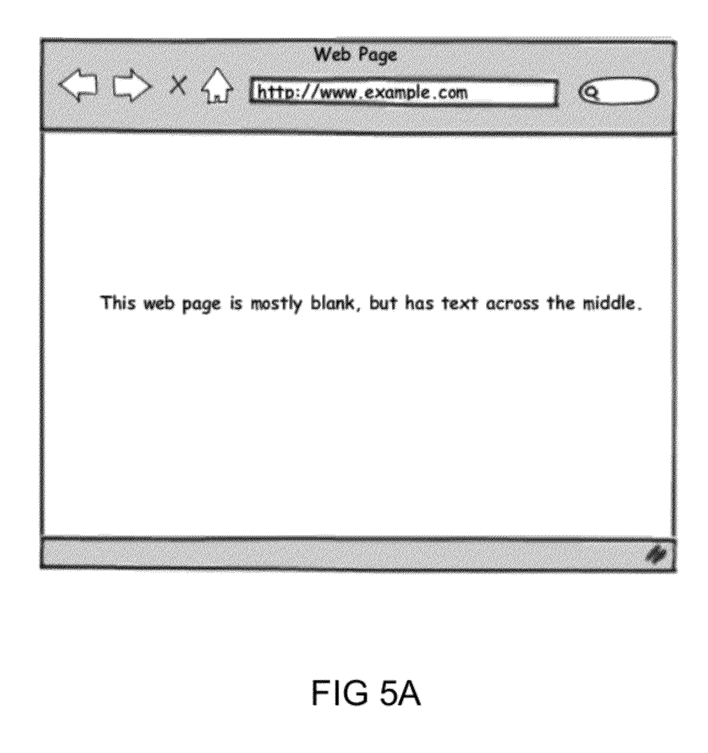

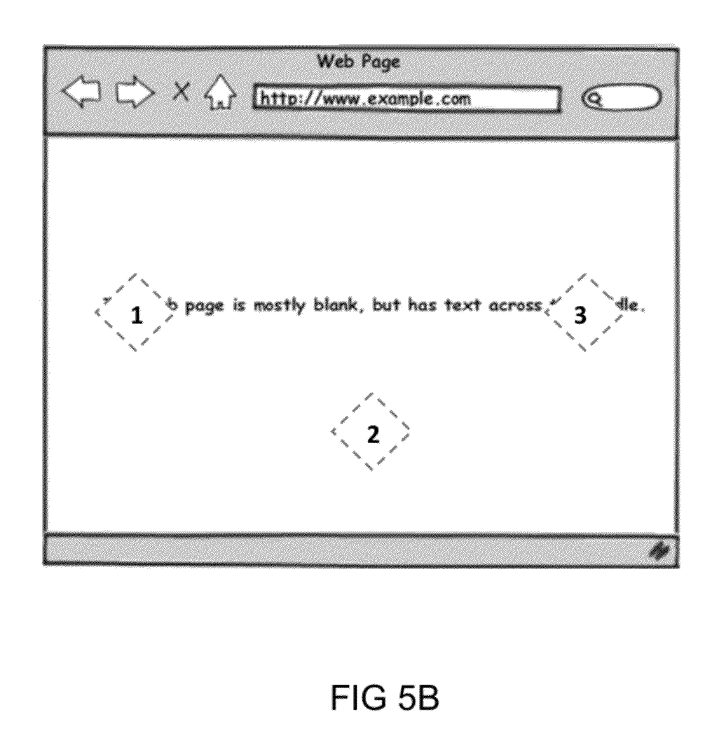

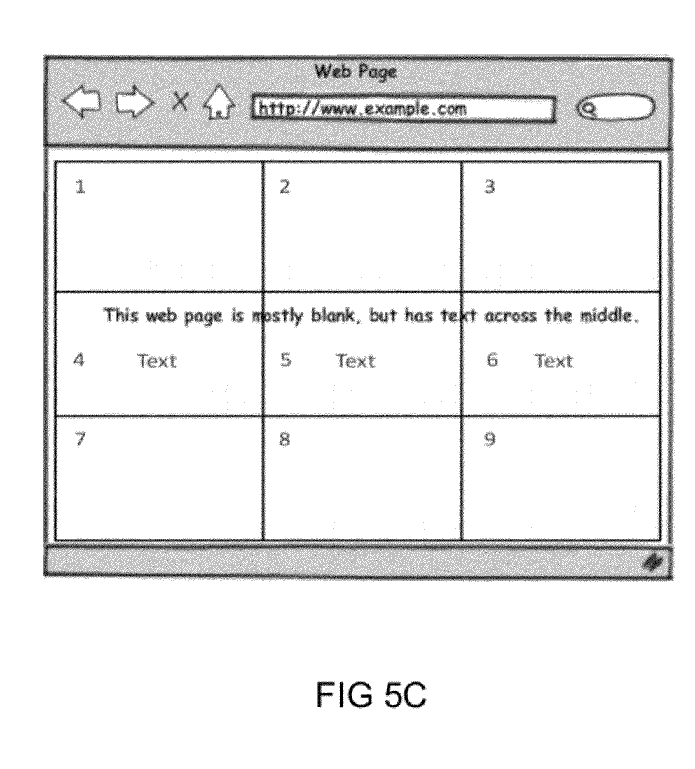

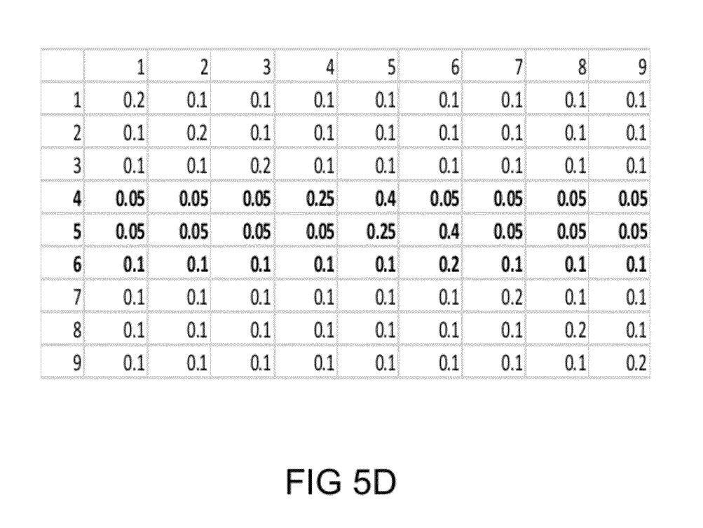

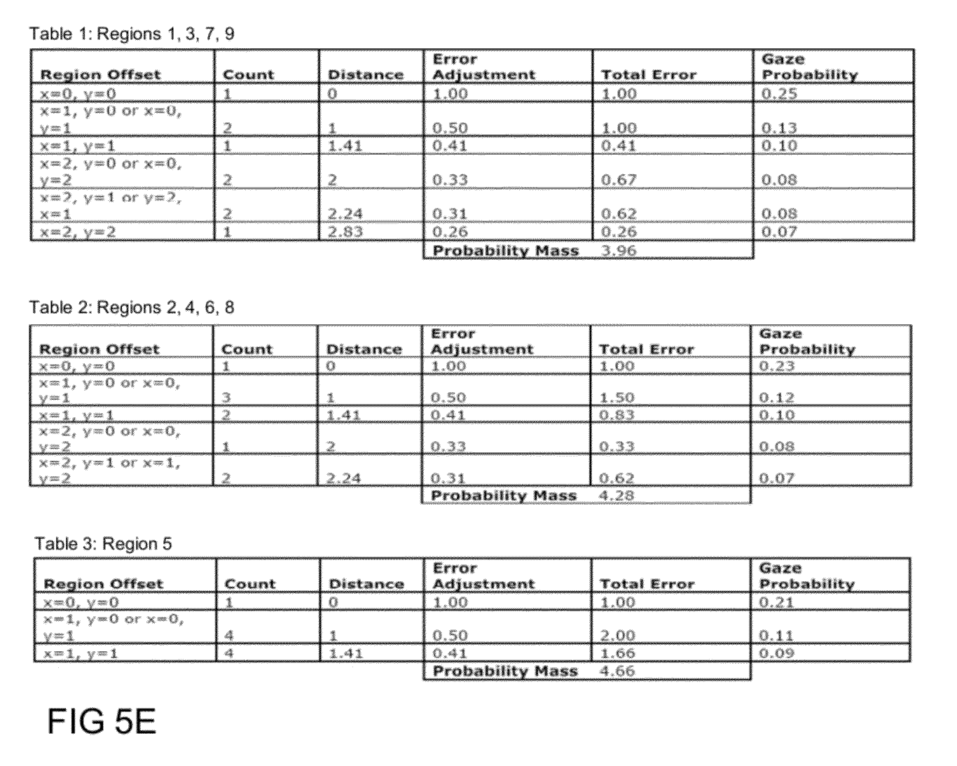

An example illustration of the present invention according to an embodiment is depicted in FIGS. 5A-5E. FIG. 5A depicts a web browser window displaying a web page containing some text. In the present example, a standard HTML web page has been used. However, any type of document may be used without deviating from the spirit or scope of the invention. FIG. 5B depicts the results of an eye tracking study on the web page, showing three points where the eye tracking mechanism estimates that the user has looked. FIG. 5C depicts a division of the webpage into discrete regions of equal size. Each region is labeled with the type of content contained within that region. Regions 4, 5, and 6 contain text whereas regions 1, 2, 3, 7, 8, and 9 are blank. This has determined by analyzing the HTML source of the webpage, which describes the document's structure and layout.

FIG. 5D depicts a table listing transition probability values for each pair of regions within the webpage. The present example focuses on transitions involving regions 4, 5, and 6. As in the previous example, a Hidden Markov model is used to model the transition probabilities, in which each region represents a possible hidden state. At each timestep, the Hidden Markov model transitions from one hidden state to another (which, in this example, may be the same state) and outputs a symbol. Transitioning between the hidden states corresponds to the user's gaze shifting to different regions within the page. The transition probability values are determined using the particular structure of the page and a set of transition rules governing the page. For instance, in the present example, the probability of transitioning from region 4 (the uppermost and rightmost occurrence of text on the page) to region 5 has been determined to be higher than the probability of transitioning to any other region, as illustrated in the table of FIG. 5D. This is because the webpage is a single-column document written in the English language, which reads from left to right.

FIG. 5E depicts tables listing gaze probability values for each of the 9 regions depicted in FIG. 5C. Gaze probability values are computed using an error function, which models the effect of noise and imprecision within the data. This effect may vary based on the type of eye-tracking mechanism used, the type of document being analyzed, the circumstances under which the data was collected, and various other factors. Any error function may be used without deviating from the spirit or scope of the invention. In the present example, the gaze probability for each region has been determined to be inversely proportional to the distance between that region and the region corresponding to the user's observed eye position as detected by the eye tracking mechanism. This is represented by the error function:

$$\frac{1}{1 + dist ( D , E )}$$

wherein D represents a region corresponding to the user's observed eye position, E represents a region for which gaze probability is to be determined, and dist(D, E) represents the distance between them.

The nine regions may be divided into three groups, wherein the regions in each group are identically situated. For example, the regions 1, 3, 7, and 9 may be grouped together because, for each of these regions, there are two regions that are offset by two regions horizontally and two regions vertically, two regions that are offset by two regions horizontally and zero regions vertically (or zero regions horizontally and two regions vertically), etc. These regions may be grouped together because they have the same sets of gaze probability values (each region is assumed to be of equal length and width). For example, the gaze probability of region 1 given an observed eye position corresponding to region 6 is equivalent to the gaze probability of region 3 given an observed eye position corresponding to region 4 because the distance between regions 1 and 6 is equivalent to the distance between regions 3 and 4. Similarly, the numbers of regions that are a particular distance from each of regions 1, 3, 7, and 9 are equivalent.

The three tables of FIG. 5E correspond to the three groups of regions. Table 1 corresponds to regions 1, 3, 7, and 9; Table 2 corresponds to regions 2, 4, 6, and 8; and Table 3 corresponds to region 5. In each table, the ‘Count’ column lists the number of regions in the document that correspond to the horizontal (x) and vertical (y) offset values listed in the ‘Region Offset’ column. The values in the ‘Distance’ column are determined using simple trigonometric functions. The ‘Error Adjustment’ for a region offset is determined by solving the error function using the distance value for that region offset. Multiplying this value by the value in the ‘Count’column yields the values in the ‘Total Error’ column for each region offset. Lastly, the gaze probability values in the rightmost column are normalized probabilities determined by dividing the values in the ‘Error Adjustment’ column by the total Probability Mass, which is the sum of the ‘Total Error’ values.

The regions corresponding to the true gaze points of the user's eye may be inferred by comparing he probabilities of each possible sequence of hidden states producing the observed output. According to one embodiment, a Viterbi algorithm is used to compute the maximally probable sequence. However, any technique for determining a maximally probable transition sequence may be used without deviating from the spirit or scope of the present invention. In the present example, the probability of the transition sequence 4→8→6 will be compared with the probability of the transition sequence 4→5→6 (for simplicity, start probabilities have been omitted from this example). In the foregoing equations, O(x,y) denotes the probability that the observed position of the user's gaze corresponds to region y if the user is actually looking at region x, and δ(x,y) denotes the probability that the user's gaze would transition from region x to region y. Thus, using the values listed in FIGS. 5D and 5E, the probability of the transition sequence 4→8→6 is given by:

P₄₈₆=O(4,4)δ(4,8)O(8,8)δ(8,6)O(6,6)=0.23×0.05×0.23×0.1×0.23=0.000060835

The probability of the transition sequence 4→5→6 is given by:

P₄₅₆=O(4,4)δ(4,5)O(5,8)δ(5.6)O(6,6)=0.23×0.4×0.11×0.4×0.23=0.00093104

Therefore, because its calculated probability value is larger, the transition sequence 4→5→6 is more likely to represent the actual direction of the user's gaze than the transition sequence 4→8→6. The Viterbi algorithm can be used to perform this analysis for all possible transition sequences, allowing the maximally probable order in which the user looked at the various regions of the document to be identified.

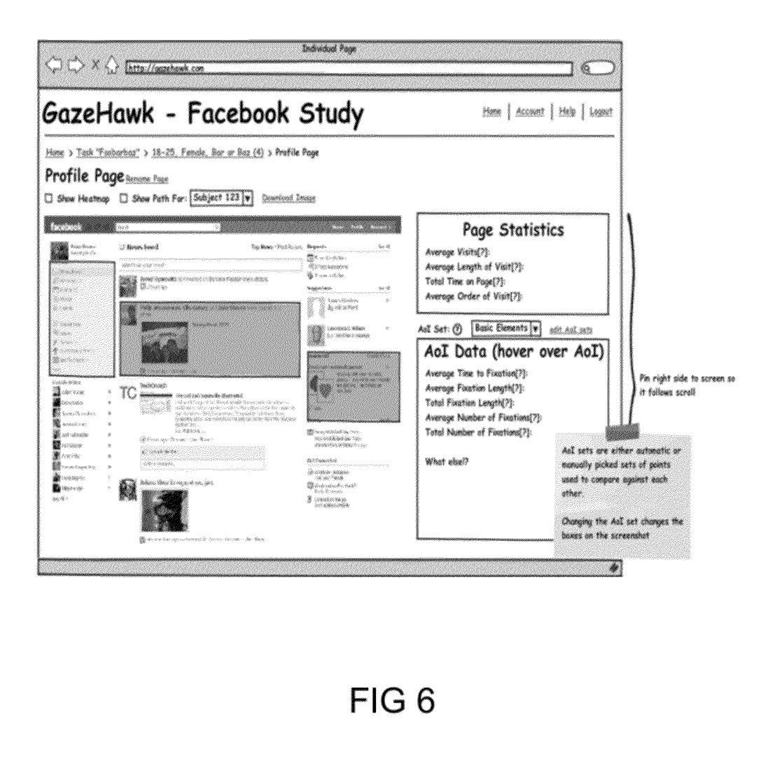

According to one series of embodiments of the present invention, when an electronic document, its structural information, and the raw data from an eye tracking study are received and processed, the document may be displayed in a visual interface with the capacity for a user to highlight and view gaze information about its various data objects. The information derived using any of the embodiments of the invention may be represented such that the user may easily discern which data object within a document was viewed the most and the sequence of the user's gaze upon the various regions of the document. One such embodiment is illustrated in FIG. 6. FIG. 6 depicts an example user interface displaying a data object and gaze analysis of a page on the popular social networking website Facebook™. In this example, the sidebar, news feed entries, and advertisements are visually identified as distinct data objects. To the right of the page are a page statistics panel and an Area of Interest (AoI) data panel listing gaze statistics for various data objects. The layout of the user interface depicted in FIG. 6 is an example; any layout may be used without deviating from the spirit or scope of the invention.

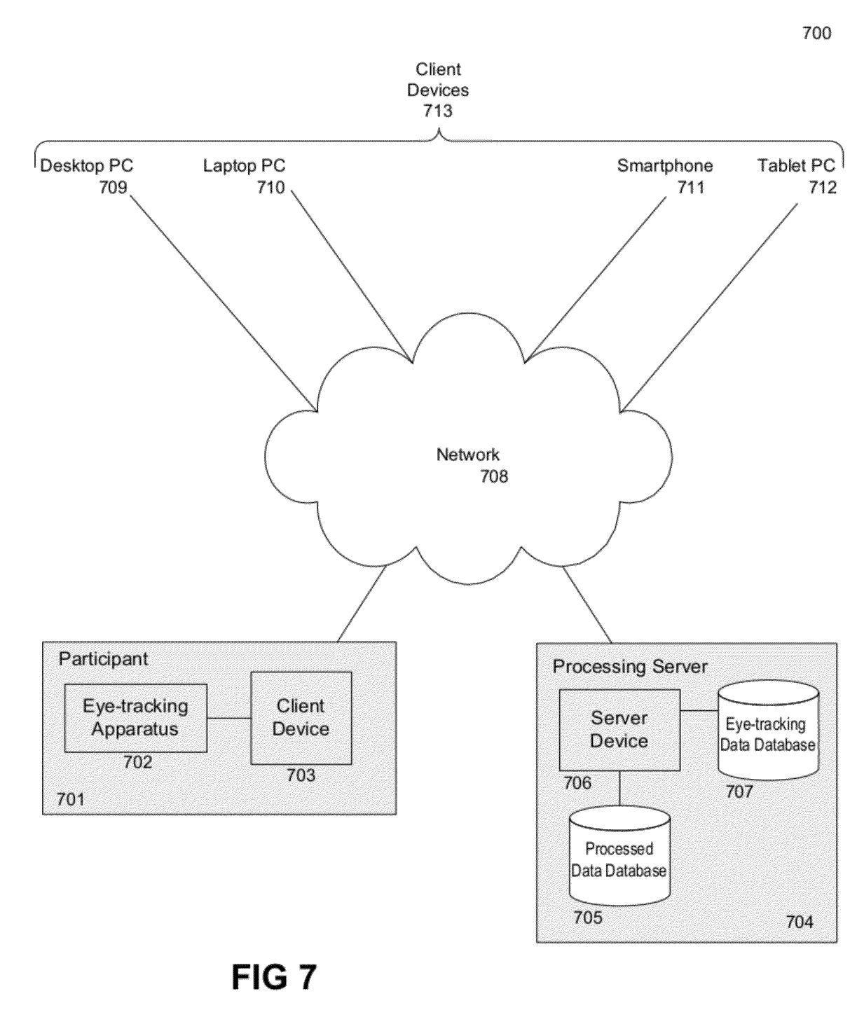

An exemplary environment within which some embodiments may operate is illustrated in FIG. 7. The diagram 700 of FIG. 7 depicts a participant 701. The participant 701 employs a computer system comprising an eye tracking apparatus 702 and a client device 703. The eye tracking device 702 may be a conventional video camera, a web camera, a still camera, or any other apparatus that can capture the positions of a participant's gaze. The eye tracking device 702 is coupled to a client device 703, which may be a desktop PC, a laptop PC, a smartphone, a tablet PC, or any other computerized device with a visual display. The client device 703 receives data tracking the position of the participant's gaze upon the visual display and transmits it via the network 708.

The data transmitted from the participant 701 via the network 708 is received by a processing server 704. The processing server comprises a server device 706, within which the operations of the embodiments described herein are executed. The server device 706 may comprise a single computer system or multiple computer systems that execute the operations in a distributed manner. The server device 706 is coupled to eye-tracking data database 707 within which the raw data received from the participant 701 is stored. The server device 706 is also coupled to a processed data database 705 within which data resulting from the operations of the embodiments described herein is stored. Each of the eye tracking data database 707 and the processed data database 705 may comprise a single database or multiple databases across which the data is distributed. The data stored in the processed data database 705 may comprise numerical values and formulae or data related to a visual interface. The processed data is transmitted by the processing server 704 via the network 708.

The processed data transmitted by the processing server 704 via the network 708 is received by viewer client devices 713. The viewer client devices 713 may include a desktop PC 709, a laptop PC 710, a smartphone 711, a tablet PC 712, or any other computerized device with a visual display. The viewer client devices display the processed data via the devices' visual display. Alternatively, any combination of the participant 701, the processing server 704, and the client device 713 may reside on the same machine.

The network 708 may comprise any combination of networks including, without limitation, the web (i.e. the Internet), a local area network, a wide area network, a wireless network, a cellular network, etc. The network 708 includes signals comprising data and commands exchanged between the participant 701, the processing server 704, and the clients 713 as well as any intermediate hardware devices used to transmit the signals.

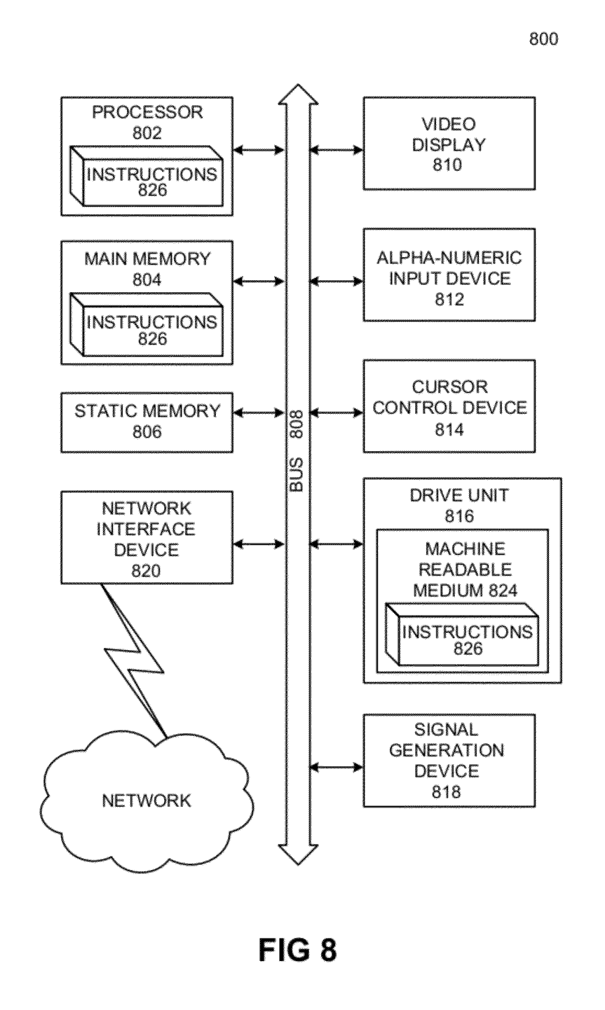

FIG. 8 depicts a diagrammatic representation of a machine in the exemplary form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker), and a network interface device 820.

The disk drive unit 816 includes a machine-readable medium 824 on which is stored a set of instructions (i.e., software) 826 embodying any one, or all, of the methodologies described above. The software 826 is also shown to reside, completely or at least partially, within the main memory 804 and/or within the processor 802. The software 826 may further be transmitted or received via the network interface device 820.

It is to be understood that various embodiments may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; or any other type of media suitable for storing or transmitting information.

In the present specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A computer implemented method for processing eye-tracking information comprising:
receiving, at a computer, data corresponding to a plurality of observed positions of a user's gaze upon an electronic document at a plurality of timesteps;
receiving, at a computer, structural data corresponding to the electronic document;
processing, at a computer, said structural data corresponding to the electronic document;
calculating, in a computer:
a plurality of transition probability values corresponding to the probability of the user's gaze transitioning from the observed positions to each of a plurality of regions within said electronic document,
a plurality of gaze probability values corresponding to the probability of determining the position of the user's gaze for each of the timesteps using the observed positions and the transition probability values, and
at least one maximally probable transition sequence using the gaze probability values and the transition probability values.

2. The computer implemented method of claim 1, wherein said transition probability values and said gaze probability values are calculated using a hidden Markov model.

3. The computer implemented method of claim 1, wherein said at least one maximally probable transition sequence is calculated using a Viterbi algorithm.

4. The computer implemented method of claim 1, further comprising receiving a plurality of transition rules, and wherein the transition probability values are further calculated using the transition rules.

5. The computer implemented method of claim 1, wherein processing said structural data corresponding to the electronic document comprises modeling said electronic document as a plurality of data objects.

6. The computer implemented method of claim 1, wherein the electronic document is a webpage.

7. The computer implemented method of claim 1, wherein the electronic document is a spreadsheet.

8. The computer implemented method of claim 1, wherein the electronic document is a word processing document.

9. The computer implemented method of claim 1, wherein the structural data is received in the form of an Extensible Markup Language (XML) schema.

10. The computer implemented method of claim 1, wherein the structural data conforms to a Document Object Model (DOM) standard.

11. A computer readable medium carrying instructions that, when executed, perform steps for processing eye-tracking information comprising:
receiving, at a computer, data corresponding to a plurality of observed positions of a user's gaze upon an electronic document at a plurality of timesteps;
receiving, at a computer, structural data corresponding to the electronic document;
processing, at a computer, said structural data corresponding to the electronic document;
calculating, in a computer:
a plurality of transition probability values corresponding to the probability of the user's gaze transitioning from the observed positions to each of a plurality of regions within said electronic document,
a plurality of gaze probability values corresponding to the probability of determining the position of the user's gaze for each of the timesteps using the observed positions and the transition probability values, and
at least one maximally probable transition sequence using the gaze probability values and the transition probability values.

12. The computer readable medium of claim 11, wherein said transition probability values and said gaze probability values are calculated using a hidden Markov model.

13. The computer readable medium of claim 11, wherein said at least one maximally probable transition sequence is calculated using a Viterbi algorithm.

14. The computer readable medium of claim 11, the steps further comprising receiving a plurality of transition rules, and wherein the transition probability values are further calculated using the transition rules.

15. The computer readable medium of claim 11, wherein processing said structural data corresponding to the electronic document comprises modeling said electronic document as a plurality of data objects.

16. The computer readable medium of claim 11, wherein the electronic document is a webpage.

17. The computer readable medium of claim 11, wherein the electronic document is a spreadsheet.

18. The computer readable medium of claim 11, wherein the electronic document is a word processing document.

19. The computer readable medium of claim 11, wherein the structural data is received in the form of an Extensible Markup Language (XML) schema.

20. The computer readable medium of claim 11, wherein the structural data conforms to a Document Object Model (DOM) standard.
